(19) United States
(12) Patent Application Publication
(10) Pub. No.: US 2026/0351637 A1
(43) Pub. Date: Nov. 5, 2026

(54) METHOD FOR DETERMINING AT LEAST ONE OPERATING PARAMETER OF AN IN-OPERATION FUEL CELL SYSTEM FOR A MOTOR VEHICLE, FUEL CELL SYSTEM, COMPUTER PROGRAM PRODUCT AND COMPUTER-READABLE MEDIUM

(71) Applicant: Robert Bosch GmbH, Stuttgart (DE)

(72) Inventors: Saskia Bostelmann, Speyer (DE); Simon Buehler, Stuttgart (DE)

(21) Appl. No.: 19/486,160

(22) PCT Filed: May 29, 2024
(86) PCT No.: PCT/EP2024/064768

§ 371 Date: Nov. 20, 2025

(30) Foreign Application Priority Data
Jun. 1, 2023 (DE) 10 2023 205 114.1

(51) Int. Cl. H01M 8/04858; B60L 58/30; H01M 8/04992

(52) U.S. Cl. CPC H01M 8/0494; B60L 58/30; H01M 8/04992; H01M 2250/20

(57) ABSTRACT

The invention relates to a method for determining at least one operating parameter of an in-operation fuel cell system (100) for a motor vehicle having at least one first cell stack (10) and a second cell stack (12). The method comprises the following steps:
(S1) providing a request for a total power (G0) to the fuel cell system (100),
(S2) controlling the first cell stack (10) to at least one predefined operating point (B) to provide a first power (G1),
(S3) during controlling of the first cell stack (10) to the at least one predefined operating point (B), controlling the second cell stack (12) to provide a remaining power such that the remaining power (G2) and the first power (G1) correspond to the total power (G0), and
(S4) determining the at least one operating parameter of the first cell stack (10) of the in-operation fuel cell system (100) based on the at least one predefined operating point (B).

### BACKGROUND

The invention relates generally to the field of fuel cell systems, in particular to the PEM fuel cell systems for motor vehicles. More specifically, the invention relates to a method for determining at least one operating parameter of an in-operation fuel cell system for a motor vehicle, fuel cell system, computer program product and computer-readable medium.

Fuel cell systems comprise one or more cell stacks. The cell stack(s) are the most expensive and critical components in a fuel cell system and are largely responsible for the efficiency of the overall system. Accurate characterization of a cell stack may, where appropriate, allow to initiate maintenance early to perform updates and/or recovery functions. A good characterization of a cell stack may also allow a stack regulation to be purposefully adjusted and/or made more precisely.

However, known methods for characterizing a cell stack or a fuel cell system can only be performed when the fuel cell system is not in operation. Known methods do not allow for accurate characterization of a fuel cell system that may be in operation. In order to be able to determine operating parameters of the fuel cell system, the fuel cell system must typically be examined in a test bench or examined by a person skilled in the art as part of a control.

### SUMMARY

The method according to the invention for determining at least one operating parameter of an in-operation fuel cell system for a motor vehicle having the features of the disclosure has the advantage that the at least one operating parameter of the fuel cell system can be reliably and precisely determined during operation of the fuel cell system. In addition, the method according to the invention has the advantage that the operation of the fuel cell system need not be disturbed by determining the operating parameter.

The proposed method is more reliable, precise, time-saving and practical than prior art methods. The proposed method enables fuel cell systems to be provided that have a longer service life than prior art fuel cell systems, because the method may detect a defect early and/or initiate maintenance.

Features and details described in connection with the method according to the invention clearly also apply in connection with the fuel cell system, computer program product and/or computer-readable medium according to the invention, and vice versa, so that mutual reference to the individual considerations of the invention always is or can be made with respect to the disclosure.

A first aspect of the present disclosure relates to a method of determining at least one operating parameter of an in-operation fuel cell system for a motor vehicle. The fuel cell system comprises at least one first cell stack and a second cell stack. The method comprises the following steps:
providing a request for a total power or total current to the fuel cell system,
controlling the first cell stack to at least one predefined operating point to provide a first power,
during controlling the first cell stack to the at least one predefined operating point, controlling the second cell stack to provide a remaining power such that the remaining power and the first power correspond to the total power, and
determining the at least one operating parameter of the first cell stack of the in-operation fuel cell system based on the at least one predefined operating point.

The fuel cell system may be embodied as a so-called twin system, meaning that two similar boxes may be combined together to form an overall system. Each box can have its own cell stack for power generation. The overall power available from the overall system, that is the fuel cell system, may be provided by the two cell stacks. To determine the at least one operating parameter of the fuel cell system, the so-called multi-box configuration may be used and the power allocation between the two cell stacks may be adjusted accordingly, at least for a predefined time. Each cell stack typically has a plurality of fuel cells.

The expression determining at least one operating parameter of the fuel cell system may be understood as a characterization of the fuel cell system. A state, such as an aging state of the fuel cell system, in particular the first cell stack, can be determined, measured, or detected. During a characterization of the fuel cell system, the fuel cell system may continue to operate. Preferably, there is no need to interrupt operation of the fuel cell system in order to determine the at least one operating parameter of the fuel cell system according to such a method. The overall power that the fuel cell system is to provide may be further provided by the fuel cell system during performance of the method so that this is not a limitation for the user of the fuel cell system.

After the overall power requirement has been provided to the fuel cell system, the first cell stack is controlled to at least one predefined operating point, wherein the at least one operating point is a predefined (first) power or a predefined power curve. The operating point may be a steady state operating point or a steady state power curve. As a rule, when controlling the first cell stack, it should continue to be able to provide power or a first power.

In other words, the first cell stack may be controlled to map a power curve where an accurate determination of an operating parameter of the fuel cell system, and in particular the first cell stack, is possible. The predefined operating point is preferably a known operating point, or an operating point at which the behavior of the first cell stack can be accurately, reliably and precisely detected and/or measured. The first cell stack may, therefore, be controlled in an operating state that corresponds to test bench conditions. Basically, the first cell stack may be controlled such that influences from the operation of the fuel cell system may be eliminated. While the first cell stack is controlled in this way, the at least one operating parameter may be determined, measured, or sensed precisely and easily.

While the first cell stack is brought to the predefined operating point or controlled, the second cell stack may be controlled in such a way that the requested total power continues to be ensured. In other words, the second cell stack may be controlled in such a way that it compensates for the lack of power due to the control of the first cell stack to at least one predefined operating point, i.e., the remaining power. The first power and the remaining power correspond to the total power available from the fuel cell system. The second cell stack can therefore map the power dynamics of the fuel cell system. The power distribution of the total power may therefore be uneven during control of the first cell stack. In particular, a normal power distribution may be interrupted to control the first cell stack to the at least one predefined operating point.

It is noted that the fuel cell system may comprise more than two cell stacks. In a fuel cell system with three or more cell stacks, it may be provided that a single cell stack is controlled to the predefined operating point for providing the first power, wherein the remaining cell stacks are all controlled such that the remaining cell stacks together provide the remaining power.

By operating the system with the first cell stack, effects resulting from the dynamics of the in-operation fuel cell system can be avoided. While the first cell stack provides the initial power or represents the operating point, the at least one operating parameter of the fuel cell system may be determined, measured, or recorded, in particular on the basis or based on known or previously known operating conditions.

The at least one operating parameter of the fuel cell system may in particular be an operating parameter of the cell stack, which is controlled to the predefined operating point. A plurality of operating parameters of the fuel cell system may be determined. For example, in addition to the operating parameter of the first cell stack, operating parameters may be determined from other components and/or elements of the fuel cell system, such as an air compressor or cooling system of the fuel cell system.

Such a method allows the fuel cell system to be characterized precisely and easily during operation, which is advantageous.

Precise determination of the at least one operating parameter can improve the power or current control of the fuel cell system, because, for example the corresponding current U-I characteristic curve of the corresponding cell stack can be used for power control.

It is advantageous if the at least one predefined operating point is a predefined power curve. For example, the power curve may be a constant power ramp. Alternatively, the power curve may be a power plateau. In principle, this may be a power curve in which empirical data, laboratory measurement data, or test bench measurement data can be used to determine very precisely at least one operating parameter of the fuel cell system, and in particular the first cell stack.

It is advantageous when the first cell stack is controlled to the at least one predefined operating point for a predefined time to provide the first power. In other words, for a predefined time, the power distribution between the two cell stacks may be controlled such that the first cell stack is controlled to the predefined operating point. Thus, the power distribution can be adjusted within the predefined time so that the second cell stack can be responsible for mapping the power dynamics.

The predefined time may be optimized with respect to the accuracy of the determination of the at least one operating parameter. Simultaneously or alternatively, the predefined time may be optimized to be as short as possible and as long as necessary (to precisely determine the at least one operating parameter), because during the time in which the first cell stack is controlled to the predefined operating point, the second cell stack can be loaded more heavily to provide the remaining power than if a normal power distribution between the two cell stacks can take place.

When the predefined time has elapsed, the power sharing or power distribution between the two cell stacks may return to the original normal power sharing.

It is advantageous if the method further comprises the steps of:
providing at least one environmental parameter,
based on the provided environmental parameter, determining or adjusting the predefined time. In other words, the duration for which the operating point is approached may be affected by environmental conditions. The longer the predefined time, the longer the second cell stack may be responsible for providing the remaining power and thus the power dynamics for the overall power. In order to minimize disruption to the operation of the fuel cell system, it may be advantageous to take environmental conditions into account so as not to place too much load on the second cell stack. The load on a cell stack can be influenced by environmental conditions.

The environmental parameter can be the ambient pressure, ambient temperature, and/or ambient humidity.

This allows the accuracy of the determination of at least one operating parameter of in-operation the fuel cell system to be further increased. In addition, the fuel cell system may thereby continue to be operated in a reliable manner during the determination of the at least one operating parameter.

Alternatively or additionally, at least one system parameter may be provided. Based on the system parameter provided, the predefined time may be determined or adjusted. The at least one system parameter may be a characteristic variable of the fuel cell system, such as, for example, the system pressure and/or the system temperature.

It is advantageous if the method further comprises the steps of:
providing at least one environmental parameter, and
based on the provided at least one environmental parameter, performing the method step of controlling the first cell stack. In other words, it is possible to weigh up whether the timing is appropriate for characterizing the fuel cell system, whereby this may depend on at least one environmental parameter provided. For example, it may be advantageous not to characterize the fuel cell system or control the first cell stack at certain ambient temperatures if, for example, it is too hot or too cold to perform, as this cannot ensure the accuracy of the determination of the at least one operating parameter. In certain ambient conditions, it may also be contemplated that determining the at least one operating parameter is not representative.

Alternatively or additionally, at least one system parameter may be provided. Based on the system parameter provided, the method step of controlling the first cell stack may (or may not) be performed. The at least one system parameter may be a characteristic variable of the fuel cell system, such as, for example, the system pressure and/or the system temperature.

It is advantageous to determine a maximum power available from the second cell stack when controlling the second cell stack. In order to be able to use the second cell stack only to a limited extent while controlling the first cell stack, a maximum power that can be provided by the second cell stack, or maximum remaining power, can be determined.

It is advantageous if the control of the first cell stack is terminated at at least one predefined operating point when, during the control of the second cell stack, the remaining power exceeds the maximum power that can be provided by the second cell stack. If a request for the total power is made to the overall system, in which the second cell stack cannot provide the remaining power, the operation can be terminated and, if necessary, repeated later. The operation may be the step of controlling the first cell stack.

Alternatively or additionally, the operation may also be terminated and later repeated when a request for total power is made to the overall system, in which the first cell stack cannot provide the first power.

As a result, both reliable operation of the fuel cell system and precise determination of the at least one operating parameter of the fuel cell system can be ensured.

It is advantageous if the at least one operating parameter of the first cell stack of the in-operation fuel cell system is a U-I characteristic curve, in particular a U-I characteristic curve of the first cell stack.

It is advantageous if the method is repeated. In so doing, the first cell stack becomes the second cell stack and the second cell stack becomes the first cell stack. The method may be repeated multiple times, wherein the first and the second cell stacks are each controlled to the at least one predefined operating point. As a result, an operating parameter of the first cell stack and one of the second cell stack can be alternately determined. The method may be repeated, in particular at certain intervals.

Instead of the total power, in the method according to the first aspect of the invention, a total current can also be used as a control variable.

A second aspect of the present disclosure is related to a fuel cell system for a motor vehicle. The fuel cell system comprises at least a first cell stack, a second cell stack and a control unit. The control unit is configured to carry out steps of the method as described above and below.

All advantages which have been explained in connection with the method according to the first aspect apply equally to the fuel cell system according to the second aspect of the present disclosure. In addition, such a fuel cell system can be particularly well and precisely maintained, because by transferring the characterization via a diagnostic interface, appropriate maintenance can be arranged, for example, depending on the specific operating parameters.

Such a fuel cell system may therefore have a very good longevity.

Furthermore, it is contemplated that the control unit initiates a recovery function and/or a restoration function depending on the specific operating parameter of the fuel cell system, in particular the first cell stack. This can reverse temporary degradation of the corresponding cell stack.

A third aspect of the present disclosure is related to a computer program product.

The computer program product comprises instructions that, when executed by a computer unit, prompt said computer unit to carry out the method as described above and below.

A fourth aspect of the present disclosure relates to a computer readable medium having stored thereon the computer program product as described above.

All disclosures and benefits described above and below with respect to one aspect of the present disclosure apply equally to all other aspects of the present disclosure.

### BRIEF DESCRIPTION OF THE DRAWINGS

In the following, exemplary embodiments of the invention are described with reference to the figures.

FIG. 1 shows a flow diagram of a method in accordance with an exemplary embodiment,

FIG. 2 schematically shows a diagram of available powers of a fuel cell system in accordance with an exemplary embodiment,

FIG. 3 schematically shows a diagram of available powers of a fuel cell system in accordance with an exemplary embodiment,

FIG. 4 schematically shows a diagram of available powers of a fuel cell system in accordance with an exemplary embodiment,

FIG. 5 schematically shows a fuel cell system in accordance with an exemplary embodiment.

### DETAILED DESCRIPTION

Similar, similarly acting, identical or identically acting elements are provided with similar or the same reference numbers in the figures. The figures are merely schematic and are not to scale.

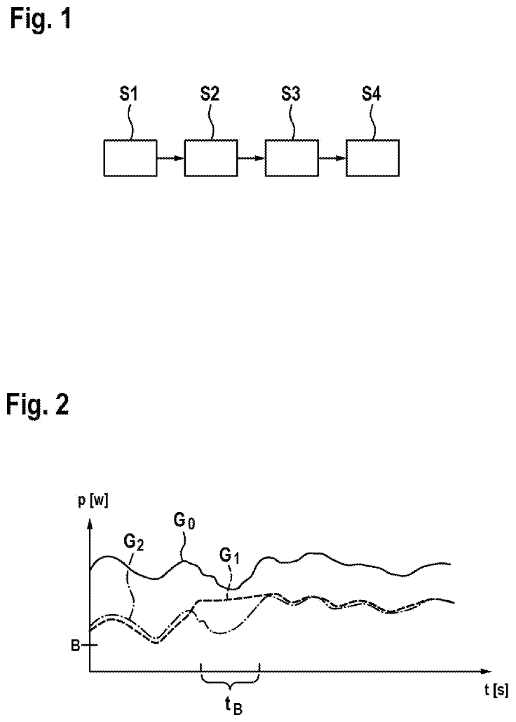

FIG. 1 shows a flow chart of a method for determining at least one operating parameter of an in-operation fuel cell system 100 according to an exemplary embodiment. The fuel cell system 100 comprises at least two cell stacks 10, 12, wherein each cell stack 10, 12 has a plurality of fuel cells. In one method step, a request for a total power G₀ is provided to the fuel cell system. Thus, in the first method stepS1, it is determined which the total power G₀ needs to be provided by the fuel cell system 100. In a second method S2 which preferably occurs immediately after the first method stepS1, the first cell stack 10 is controlled to at least one predefined operating point B, such as a stationary operating point B, for providing a first power G₁, such as from a control unit 14. During the second method step i.e., preferably simultaneously with the second method S2, in a third method stepS3, while controlling the first cell stack to at least one predefined operating point B, the second cell stack 12 is controlled to provide a remaining power G₂ such that the remaining power G₂ and the first power G₁ corresponds to the total power G₀. That is to say, while the first cell stack 10 is controlled in such a way that it can be characterized, the second cell stack 12 may compensate for the resulting power loss. Overall, the two cell stacks may be controlled such that the request for the total power G₀ of the fuel cell system 100 may be met at all times. In a fourth method step S4, the at least one operating parameter, such as the U-I characteristic curve, of the first cell stack of the in-operation fuel cell system 100 may be determined based on the at least one predefined operating point B. In so doing, the at least one operating parameter or multiple operating parameters may be measured. In the fourth step S4, for example, the specific operating parameter can be compared with past specific operating parameters in order to determine, for example, a shift (over time) in the U-I characteristic curve.

Based on the determined at least one operating parameter of the first cell stack of the in-operation fuel cell system 100, maintenance or a maintenance operation may be initiated by a control unit 14. In particular, the corresponding cell stack, the entire fuel cell system 100, components and/or elements of the fuel cell system 100 may be replaced, cleaned, and/or serviced.

FIG. 2 schematically shows a diagram of available powers of a fuel cell system in accordance with an exemplary embodiment. On the vertical axis, the power is shown in watts. On the vertical axis, the time is shown in seconds. The requirement for the entire fuel cell system represents the total power output G₀. The fuel cell system 100, and in particular the cell stacks of the fuel cell system, are therefore preferably controlled such that the total output G₀ is available at any time from the in-operation fuel cell system 100. The in-operation fuel cell system 100 of FIG. 2 has a first cell stack 10 and a second cell stack 12. If the first cell stack 10 is not currently controlled at the predefined operating point, the two cell stacks 10, 12 may equally contribute to providing the total power. The first cell stack may provide a first power G₁ corresponding to 50% of the total power G₀, and the second cell stack may provide a remaining power G₂ which also corresponds to 50% of the total power G₀. Generally, when the first cell stack is not controlled at the predefined operating point, this can be referred to as normal power distribution. A normal power distribution may also be non-uniform. A decisive factor in the normal power distribution may be that all cell stacks of the fuel cell system reflect the power dynamics of the entire fuel cell system.

During a predefined time t_{B}, in the example of FIG. 2, the first cell stack 10 is controlled at a steady state operating point to provide the first power G₁. The first power G₁ may represent more than 50% of the total power G₀ during the predefined time t_{B}. During the predefined time t_{B}, the second cell stack 12 may provide the remaining power G₂. At this time, the at least one operating parameter of the first cell stack 10 may be determined, measured, or recorded. After the predefined time, the power distribution may return to the original sharing, such as the normal power distribution.

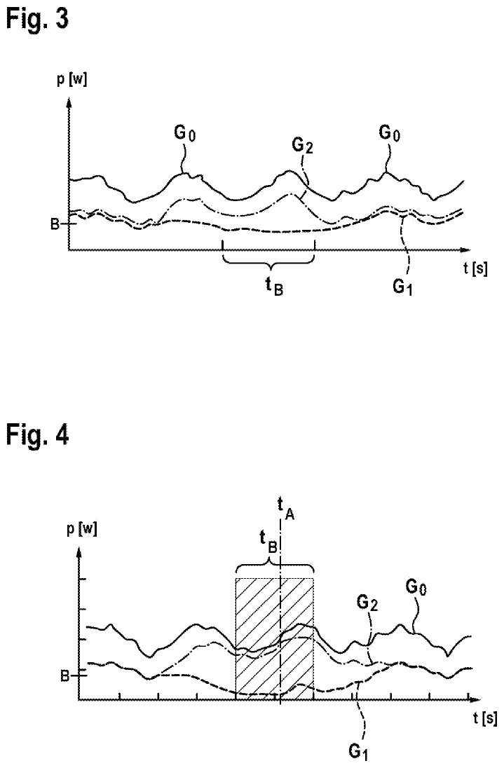

FIG. 3 schematically shows a diagram of available powers of a fuel cell system in accordance with an exemplary embodiment. In contrast to FIG. 2, in the graph of FIG. 3 the first power G₀ during t_{B} is lower than the remaining power G₁.

FIG. 4 schematically shows a diagram of available powers of a fuel cell system 100 in accordance with an exemplary embodiment. In FIG. 4, at t_{A}, control of the first cell stack 10 was interrupted. The second cell stack 12, which is used to compensate for the power loss resulting from the control of the first cell stack 10 during the predefined time t_{B}, could no longer provide the necessary remaining power G₂ from time t_{A} onwards to ensure the total power G₀. In other words, the second cell stack 12 has exceeded a maximum power available from the second cell stack. In response to this, a control unit 14 of the fuel cell system may interrupt or terminate the process of controlling the first cell stack 10, and in particular determining the at least one operating parameter of the first cell stack 10. The operation may be repeated, for example, at a later time if the ambient conditions have changed.

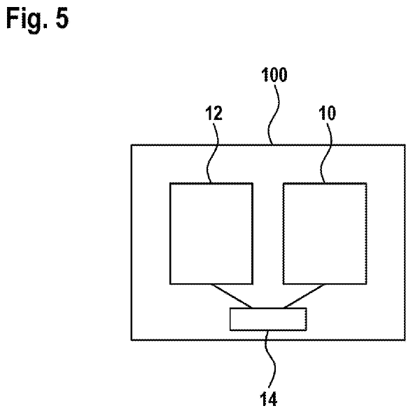

FIG. 5 schematically shows a fuel cell system 100 in accordance with an exemplary embodiment. The fuel cell system 100 of FIG. 5 has two cell stacks 10, 12. It is contemplated that the fuel cell system 100 will have three or more cell stacks. The fuel cell system 100 also includes a control unit 14. The control unit 14 is configured to perform the method according to the first aspect of the present invention, for example as explained by the flowchart of FIG. 1. It is noted that the method is preferably to be repeated at least as often as the number of cell stacks of the fuel cell system 100. If the fuel cell system 100 comprises three cell stacks, the method should typically be repeated at least three times, such that each time the method is performed, a different cell stack becomes the first cell stack 10. The fuel cell system 100 may also include other components and/or elements (not shown here), such as an air compressor and/or a cooler. The fuel cell system 100 may also include a diagnostic interface configured to transmit the at least one particular operating parameter of fuel cell system 100 to, for example, an external controller or user device.

In addition, it should be noted that terms such as “having”, “comprising”, etc. do not exclude other elements or steps and indefinite articles such as “a” or “an” do not exclude a plurality. Furthermore, it should be noted that features and steps described with reference to any of the above exemplary embodiments may also be used in combination with other features and steps of other exemplary embodiments described above. Reference signs in the claims should not be construed as limitations.

1. A method for controlling a fuel cell system (100) and determining an operating parameter of the fuel cell system (100), the fuel cell system (100) having a first cell stack (10) and a second cell stack (12), the method comprising
(S1) providing a request of a total power (G₀) or a total flow to the fuel cell system (100),
(S2) controlling the first cell stack (10) to predefined operating point (B) to provide a first power (G₁),
(S3) during controlling of the first cell stack (10) to a predefined operating point (B), controlling the second cell stack (12) to provide a remaining power such that the remaining power (G₂) and the first power (G₁) correspond to the total power (G₀), and
(S4) determining the operating parameter of the first cell stack (10) of the fuel cell system (100) based on the predefined operating point (B).

2. The method according to claim 1, wherein the predefined operating point is a predefined power curve.

3. The method according to claim 1,
wherein
the first cell stack (10) is controlled to the predefined operating point (B) for a predefined time (t_{B}) to provide the first power (G₁).

4. The method according to claim 3,
wherein
the method further comprises
providing an environmental parameter, and
based on the provided environmental parameter, determining or adjusting the predefined time (t_{B}).

5. The method according to claim 1,
wherein
the method further comprises
providing an environmental parameter, and
based on the environmental parameter provided, performing the method step of controlling the first cell stack (10).

6. The method according to claim 1,
wherein
a maximum power available from the second cell stack (12) is determined when controlling the second cell stack (12).

7. The method according to claim 6,
wherein
controlling the first cell stack (10) to a predefined operating point (B) is terminated, when the remaining power (G₂) exceeds the maximum power available from the second cell stack (12).

8. The method according to claim 1,
wherein
the operating parameter of the first cell stack (10) of the in-operation fuel cell system (100) is a U-I characteristic curve.

9. The method according to claim 1,
wherein
the method is repeated, wherein the first cell stack (10) becomes the second cell stack (12) and the second cell stack (12) becomes the first cell stack (10).

10. A fuel cell system (100) for a motor vehicle comprising at least a first cell stack (10), a second cell stack (12) and a control unit (14), wherein the control unit (14) is configured to carry out the method according to claim 1.

11. (canceled)

12. A non-transitory, computer-readable medium comprising instructions that when executed by a computer cause the computer to control a fuel cell system (100) and determine an operating parameter of the fuel cell system (100), the fuel cell system (100) having a first cell stack (10) and a second cell stack (12), by:
providing a request of a total power (G₀) or a total flow to the fuel cell system (100),
controlling the first cell stack (10) to a predefined operating point (B) to provide a first power (G₁),
during controlling of the first cell stack (10) to a predefined operating point (B), controlling the second cell stack (12) to provide a remaining power such that the remaining power (G₂) and the first power (G₁) correspond to the total power (G₀), and
determining the operating parameter of the first cell stack (10) of the fuel cell system (100) based on the predefined operating point (B)program
